(19) United States
(12) Patent Application Publication
(10) Pub. No.: US 2008/0063838 A1
(43) Pub. Date: Mar. 13, 2008

(54) Film Carrier Tape for Mounting Electronic Components and Method of Manufacturing the Film Carrier Tape

(75) Inventors: Hiroaki Kurihara, Tokyo (JP); Naoya Yasui, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: MITSUI MINING & SMELTING CO., LTD., Tokyo (JP)

(21) Appl. No.: 11/850,361

(22) Filed: Sep. 5, 2007

(30) Foreign Application Priority Data
Sep. 5, 2006 (JP) 2006-240856

(51) Int. Cl. D06N 7/04; B44C 1/17

(52) U.S. Cl. 428/141; 156/233

(57) ABSTRACT

A film carrier tape for mounting electronic components has a wiring with a wire pitch of 35 μm or less. A method for manufacturing such film carrier tape is also disclosed. The film carrier tape for mounting electronic components is manufactured using a specific flexible conductor foil clad laminate as a wiring forming material. The flexible conductor foil clad laminate includes a base film and a conductor foil having a surface roughness (Rzⱼᵢₛ) of a bonded surface of 2.5 μm or less and a surface roughness (Rzⱼᵢₛ) of a resist-side surface of 1.0 μm or less. The flexible conductor foil clad laminate may be a flexible copper clad laminate in which a glossy-surface-processed electrolytic copper foil has a surface roughness (Rzⱼᵢₛ) of a bonded surface of 2.5 μm or less and a surface roughness (Rzⱼᵢₛ) of a resist-side surface of 1.5 μm or less and in which the copper foil is half etched as required to not less than half an original thickness.

### BACKGROUND OF THE INVENTION

1. Field of the Invention

The present invention relates to a film carrier tape for mounting electronic components having a wiring of 35-μm pitch or less, and a stable manufacturing method of the film carrier tape for mounting electronic components.

2. Description of the Related Art

Conventionally, a flexible copper clad laminate (hereinafter sometimes referred to as “FCCL”) has been frequently used in order to effectively arrange a wiring board in a narrow area by utilizing its good bendability in accordance with the demand for miniaturization and multifunctionalization of electronic devices. A film carrier tape for mounting electronic components (hereinafter simply referred to as film carrier tape) is one example of usage of the flexible copper clad laminate in which smoothness of the surface is utilized together with the bendability. While there is a demand for downsizing electronic and electric devices which use a printed wiring board or reducing the weight of these devices, i.e., when there is a demand for making these devices light in weight, thin in thickness, short in length, and small in size, the film carrier tape for mounting electronic components has been developed on which an IC chip or LSI chip can directly be mounted. The film carrier tape has been employed here and there for manufacturing a CSP or mounting a liquid crystal driver element.

High integration technology has caused microfabrication of connection pads of a component to be mounted. Consequently, the film carrier tape is required to have fine-pitch inner leads on which the component is directly connected. Therefore, manufacturers of the film carrier tapes have coped with this demand by employing a thinner copper foil so as to shorten the overetching time when a wiring is formed by pattern etching, to thereby enhance an etching factor of the wiring formed. In order to ensure the connection reliability, the leads should be fine but at the same time should have as large a size as possible for the size of pads of the component to be mounted. Specifically, it is a significant subject how to produce an ideal wiring form.

In view of this, in a chip on film (COF) substrate among tape automated bonding (TAB) substrates that are frequently used as film carrier tapes for mounting electronic components, a copper foil having a profile lower than an ordinary rigid printed wiring board is employed, with the result that the thickness of the conductor is reduced. It is to be noted that the low profile means that the irregularity (profile) is low at the junction interface of the copper foil to a base film. In JIS C 6515 that is the standard for copper foils for printed wiring boards, the numerical value of the surface roughness (Rzⱼᵢₛ) obtained by the measurement with the use of a contact type roughness tester is used as an index.

As a result, techniques disclosed in Japanese Patent Application Laid-Open No. 5-82590, Japanese Patent Application Laid-Open No. 2002-198399, and Japanese Patent Application Laid-Open No. 2005-64074 have been proposed in order to meet the high requirements described above, and an optimum technique has been selected and used appropriately. Specifically, these techniques include a method in which a glossy surface, which is a low-profile surface, of an electrolytic copper foil obtained by electrolysis of sulfuric acid copper plating solution, is bonded to a base film; a method in which an unnecessary portion of a conductive layer is preliminarily removed by etching to a minimum required thickness; and a pattern-plating/flash-etching method in which a very thin conductive film is formed, then, a conductive metal is pattern-plated on an appropriate conductive film portion, and then, an unnecessary conductive film portion is dissolved and removed in a short period.

In the technique disclosed in Japanese Patent Application Laid-Open No. 5-82590, a glossy surface of an electrolytic copper foil is roughened with metallic particles to a height of 0.2 to 1.0 μm. The roughened surface of the electrolytic copper foil is used as a bonded surface and is bonded to a base film. (In the present invention, the mating surfaces of a conductive foil or wiring pattern and a base film are referred to as the “bonded surfaces”). Thus, a flexible copper clad laminate is formed. The glossy-surface-processed electrolytic copper foil is RTF (Reverse Treated Foil) prescribed in IPC 4562 that is the standard of copper foils for printed wiring boards, wherein the roughening process is performed to the glossy surface. Thereafter, the exposed deposition surface, which is opposite to the glossy surface, is half-etched so as to form a resist-side surface having a surface roughness (Rzⱼᵢₛ) of less than 3.0 μm. (In the present invention, the “resist-side surface” refers to a conductive metal surface of a conductive foil or wiring pattern which is exposed and on which a resist coating film such as an etching resist will be formed for forming a wiring pattern.) According to this embodiment, the surface roughness of the deposition surface of the electrolytic copper foil to be half-etched, is as large as 3 μm to 12 μm in Rzⱼᵢₛ. Therefore, when the smoothness of the conductive layer is to be achieved, a large amount of the copper foil should be half-etched, so that the variation in the thickness is increased. Specifically, there is a limit in achieving both the smoothness of the surface and the uniform thickness. As a result, even after the surface is smoothed, the influence of the initial irregularity on the deposition surface of the electrolytic copper foil remains, although it is only less than 3 μm in Rzⱼᵢₛ. Therefore, when a pattern etching resist film is formed, edge surfaces of the resist film cannot precisely follow the contour of the pattern mask. Accordingly, 50 μm pitch has been considered to be substantial limit in forming a wiring. Further, the variation in the thickness of the copper foil leads to the difference in the undercut amount produced by the overetching, which gives great effect on the variation in the linewidth.

In the technique disclosed in Japanese Patent Application Laid-Open No. 2002-198399, a glossy-surface-processed electrolytic copper foil having a thickness of 12 μm is bonded to a base to form a flexible copper clad laminate. This flexible copper clad laminate is half-etched, and then a wiring is formed. According to a disclosed embodiment, a wiring having a pitch of 30 μm is formed using a flexible copper clad laminate that is half-etched to 5 μm. Meanwhile, the wire pitch indicates a width that is a total of a linewidth and a space between wires, and it is not always designed in such a manner that the linewidth and the space width between the wires in one pitch, i.e., linewidth/space width (hereinafter referred to as L/S) are equal to each other. Specifically, in forming a printed wiring board having 40-μm pitch, a concept has been applied in which the space width is greater than the linewidth in order to ensure the space between the wires for the purpose of preventing the occurrence of whisker or short circuits due to migration. For example, in a printed wiring board having 40-μm pitch, L/S is 15 μm/25 μm.

Specifically, since there is a variation in the linewidth in the current technical situation, it is difficult in a fine-pitch wiring that the total width of the insulating portion except for the conductor projecting or partially remaining between the wires should be ⅔ or larger (requirement in the general wiring standard) of the designed space between the wires. Moreover, even if the objective fine pitch is achieved, the linewidth is reduced in the design concept described above. Therefore, the positioning of the components to be mounted becomes difficult, and additional problems arise in the connection reliability such as the mounted components falling off in a drop impact test due to the reduced area of connection.

Japanese Patent Application Laid-Open No. 2005-64074 discloses a technique in which a copper foil having a thickness of 10 μm to 15 μm is used in a flexible copper clad laminate that is a base, the copper foil is half-etched to a thickness of 1.5 μm to 4.0 μm, a plating resist is formed, a copper pattern is deposited to a predetermined thickness, the resist is removed, and the thin conductive portion is removed by flash etching. According to this method, the management of the in-plane variation in the thickness of the conductor is difficult in the case where the thickness of the copper foil is reduced to one-fourth or less the original thickness, as described with regard to Japanese Patent Application Laid-Open No. 5-82590. Therefore, the minimum thickness after the etching is set at 1.5 μm in which pinholes are not produced in the conductive layer. This technique entails a problem that the in-plane variation in the thickness of the conductive layer and the variation in the thickness of the pattern deposit formed in a subsequent step affect the variation in the linewidth (and thickness) of the wires obtained after the flash-etching. Therefore, this technique for manufacturing a printed wiring board requires many management items involving a high level of processing and therefore has problems in stably producing fine pitch wirings. Furthermore, it is difficult to form electrical characteristics such as impedance required for a wiring that executes a high-speed signal processing.

As apparent from the above, there have been no film carrier tapes for mounting electronic components in which a pad or a lead formed on a wiring board has an optimum shape for the mounting of components and which has a wiring with a pitch of 35 μm or less, and there have been no established techniques capable of stably producing such film carrier tapes for mounting electronic components.

As described above, there have been no film carrier tapes for mounting electronic components which have a wiring board with a fine-pitch wiring in which a pad and/or a lead has an ideal shape as demanded by a functional component to be mounted and in which the wiring board has reliability.

### SUMMARY OF THE INVENTION

As a result of serious efforts for the purpose of solving the aforesaid problems, the present inventors have found that a film carrier tape for mounting electronic components having a fine-pitch wiring whose pitch is not more than 35 micrometers, which has conventionally been difficult to achieve, can stably be produced with the use of a specific flexible conductor foil clad laminate as a wiring forming material which is composed of a base film and a conductor foil having a bonded surface with a surface roughness (Rzⱼᵢₛ) of 2.5 μm or less and a resist-side surface with a surface roughness (Rzⱼᵢₛ) of 1.0 μm or less.

The means for solving the foregoing problems will be described below.

A film carrier tape for mounting electronic components according to the present invention is obtained by using a flexible conductor foil clad laminate comprising a conductor foil and a base film, wherein the surface roughness (Rzⱼᵢₛ) of a surface of the conductor foil bonded to the base film is 2.5 μm or less, and the surface roughness (Rzⱼᵢₛ) of a resist-side surface of the conductor foil is 1.0 μm or less.

It is preferable that the glossiness [Gs (60°)] of the resist-side surface of the conductor foil is 400 or more.

It is also preferable that the flexible conductor foil clad laminate is a flexible copper clad laminate comprising a surface-processed electrolytic copper foil and a base film.

It is more preferable that the flexible conductor foil clad laminate is a flexible copper clad laminate comprising a surface-processed electrolytic copper foil and a base film and a surface of the surface-processed electrolytic copper foil is smoothed by etching.

It is preferable that the flexible conductor foil clad laminate is a flexible copper clad laminate comprising a surface-processed electrolytic copper foil and a base film wherein a surface of the surface-processed electrolytic copper foil is smoothed by etching (hereinafter, the etched FCCL will be referred to as FCCL-HE), and the flexible copper clad laminate is prepared from a flexible copper clad laminate starting material (hereinafter, the flexible copper clad laminate starting material will be referred to as FCCL-SM) in which a surface-processed electrolytic copper foil has a resist-side surface with a surface roughness (Rzⱼᵢₛ) of 1.5 μm or less.

It is also more preferable that the flexible conductor foil clad laminate is a flexible copper clad laminate (FCCL-HE) comprising a surface-processed electrolytic copper foil and a base film wherein a surface of the surface-processed electrolytic copper foil is smoothed by etching, and the FCCL-HE is prepared from a FCCL-SM by etching a surface-processed electrolytic copper foil which constitutes the FCCL-SM and which is 9 μm to 23 μm in thickness, to not less than half the original thickness.

It is also more preferable that the flexible conductor foil clad laminate is a flexible copper clad laminate comprising a surface-processed electrolytic copper foil and a base film, and the surface-processed electrolytic copper foil constituting the flexible copper clad laminate is a glossy-surface-processed electrolytic copper foil.

It is also preferable that the film carrier tape for mounting electronic components has a difference of not more than 3.0 μm between a maximum width and a minimum width in a continuous linear wire.

It is also preferable that a wiring formed in the film carrier tape for mounting electronic components has a wire pitch of 20 μm to 35 μm, and the space margin in the wiring which is calculated with the use of the following equation 1 is not less than 82%.
Space margin(%)=(wire pitch(μm)−maximum linewidth(μm))/(wire pitch(μm)−minimum linewidth(μm))×100 [Equation 1]

A manufacturing method of a film carrier tape for mounting electronic components according to the present invention is a manufacturing method of the above-mentioned film carrier tape for mounting electronic components, and is characterized in that a flexible copper clad laminate obtained by steps a and b described below is used as the flexible conductor foil clad laminate:

Step a: a glossy-surface-processed electrolytic copper foil is bonded to a base film to produce a flexible copper clad laminate starting material, the electrolytic copper foil having a surface roughness (Rzⱼᵢₛ) of a surface bonded to the base film of 2.5 μm less, and a surface roughness (Rzⱼᵢₛ) of a resist-side surface of 1.5 μm or less;

Step b: the glossy-surface-processed electrolytic copper foil constituting the flexible copper clad laminate starting material is etched as required to not less than half an original thickness, thereby to make the surface roughness (Rzⱼᵢₛ) of the resist-side surface 1.0 μm or less.

The film carrier tape for mounting electronic components according to the present invention is obtained using the above flexible conductor foil clad laminate as a wiring forming material. The flexible conductor foil clad laminate is composed of a base film and a conductor foil having a bonded surface with a surface roughness (Rzⱼᵢₛ) of 2.5 μm or less and a resist-side surface with a surface roughness (Rzⱼᵢₛ) of 1.0 μm or less. By the use of the flexible conductor foil clad laminate, a wiring can be formed at a fine pitch of not more than 35 μm which has been difficult in the conventional art, at conventional costs without drastic changes of processing process. In spite of having a fine pitch, the wiring produced according to the present invention is resistant to cracks originating from irregularities of edge surfaces of the wiring, even when very small repeated stress is applied due to thermal expansion or thermal shrinkage of the film carrier or even when large stress is applied in bonding electronic components to the film carrier.

### BRIEF DESCRIPTION OF THE DRAWINGS

FIG. 1 is a schematic view of a section of a wiring pattern obtained when there is no waviness at a junction interface;

FIG. 2 is a schematic view of a section of a wiring pattern obtained when there is waviness at a junction interface;

FIG. 3 is a photograph (×350) of the wiring pattern used for evaluation in Example 1;

FIG. 4 is a photograph (×1,000) of the wiring pattern evaluated in Example 1; and

FIG. 5 is a photograph (×1,000) of the wiring pattern evaluated in Comparative Example 1.

### DESCRIPTION OF THE PREFERRED EMBODIMENTS

A film carrier tape for mounting electronic components according to the present invention is obtained by using a flexible conductor foil clad laminate composed of a conductor foil and a base film. The surface of the conductor foil bonded to the base film has a surface roughness (Rzⱼᵢₛ) of 2.5 μm or less and the resist-side surface has a surface roughness (Rzⱼᵢₛ) of 1.0 μm or less.

The surface roughness (Rzⱼᵢₛ) of the bonded surface of the conductor foil is 2.5 μm or less. A roughening process is generally performed to the bonded surface in order to stabilize the adhesion between the conductor foil and the base film. The roughening process may be carried out by one or more of the techniques including forming metallic particles and making the surface porous by etching. When metallic particles are formed, the metallic particles are embedded into an adhesive or base film that is an insulating resin. In view of the insulating reliability between wires, a space width should be ensured in consideration of this portion. The present inventors have estimated an influence of the linearity of the wire on the space width, supposing that the diameter of the metallic particles is about 1.0 μm. The result is as follows. When the space width is 15 μm, the metallic particles will reduce the space margin by 13% maximum if they protrude from neighboring wires to a full length of the particle, namely 1 μm. The space margin reduction by such protruding particles is 16% when the space width is 12.5 μm, and 20% when the space width is 10 μm. Accordingly, when the space width is 10 μm, the particle diameter permitting a space margin of 82% is approximately 1 μm. In order that the space margin is in a predetermined range, the variation in linewidth, particularly at the bottom of the wiring, should be small.

Next, the surface roughness of the bonded surface after the roughening process is considered in view of the diameter of the particles. Specifically, exemplary surface-processed electrolytic copper foils used for copper clad laminates for printed wiring boards are considered on the basis of the experiences of the present inventors. In a glossy-surface-processed electrolytic copper foil to which copper particles of approximately 1.0 μm are attached, the surface roughness (Rzⱼᵢₛ) of the bonded surface of the copper foil is approximately 2.5 μm by the synergy with the surface roughness (Rzⱼᵢₛ) of the glossy surface of the electrolytic copper foil (1.2 to 2.0 μm in general electrolytic copper foils), although it depends upon the technique for forming copper particles. Therefore, it can be said that Rzⱼᵢₛ≦2.5 μm is an allowable range of the surface roughness of the bonded surface. However, in the measurement method of Rzⱼᵢₛ, waves are neglected based on a cutoff value of 0.8 mm. That is, waves at a pitch exceeding 0.8 mm are canceled. It should be noted that the waviness at a small pitch is reflected in the surface roughness of the wires at an objective pitch of several tens micrometers in the invention. In the FCCL, the shape of the bonded surface can be considered directly as the shape of the junction interface layer.

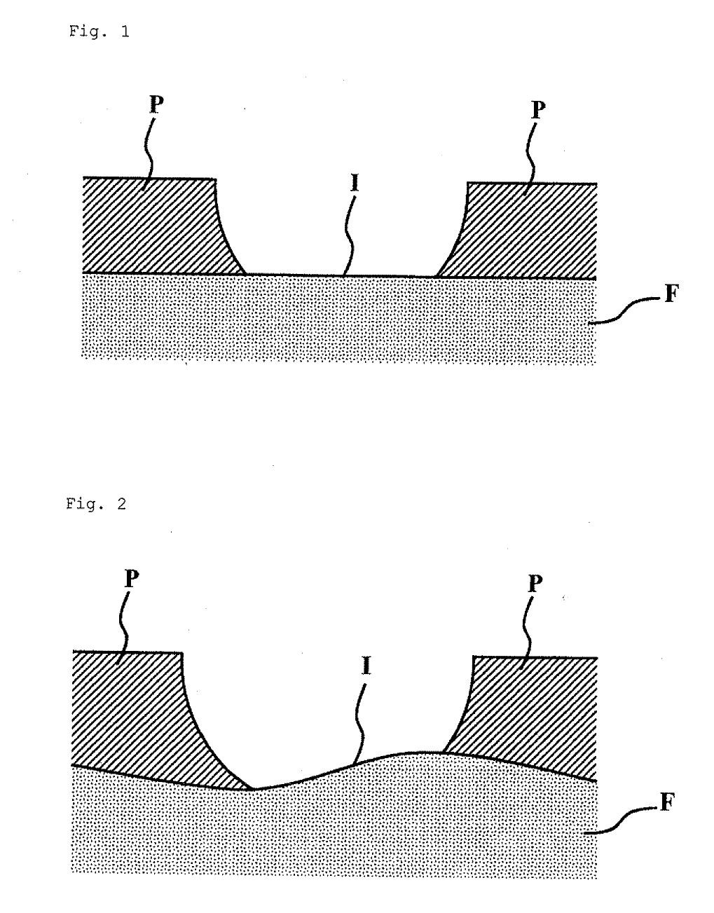

The sectional shape of the pattern-etched edge surfaces of the conductive metal can be represented by a function of the thickness of the conductor and the space width. The sectional shape is approximately similar to a part of an outer peripheral shape of an ellipse or circle that can be fitted into the space between wires. Therefore, as schematically shown in FIG. 1, when a junction interface I between a conductive metal P and a base film F is flat, the sectional shapes of both edge surfaces of the wire are similar. On the other hand, when there is waviness at the junction interface I between the conductive metal P and the base film F as schematically shown in FIG. 2, the edge surfaces of the wire are more perpendicular when they are on a peak of the waviness on the bonded surface, while the edge surfaces are less perpendicular when they are on a valley of the waviness. Consequently, the edge surfaces of the wiring are waved corresponding to the distribution of the waviness, which is a great restriction in the manufacturing of fine-pitch printed wiring boards.

In the film carrier tape for mounting electronic components of the invention, the surface roughness (Rzⱼᵢₛ) of the bonded surface reflects the waviness and is adjusted to 2.5 μm or less, whereby the linearity is satisfactory and consequently the space width is ensured. When a three-dimensional surface structure analyzing microscope is used and a low-frequency filter is set at 11 μm so as to obtain three-dimensional data relating to the surface shape, and the obtained data is compared to the linearity of the edge surfaces of the wiring, it is found that it is preferable for the formation of a 20 μm-pitch wiring that the maximum height (sum of the maximum height of the peaks and the maximum depth of the valleys: Wmax) of the waveform data is 0.7 μm or less. This threshold value can be determined with, for example, the waviness or RSm obtained by using a contact-type roughness tester as an index.

However, since a person skilled in the art can easily conceive that a wiring having narrower spaces can be formed depending upon the setting of other conditions as described above, 10 μm is not the lower limit of the space width of the wiring which can be formed when the surface roughness (Rzⱼᵢₛ) of the bonded surface is 2.5 μm. Naturally, the lower-limit of the space width is different depending upon the required precision.

The surface roughness (Rzⱼᵢₛ) of the resist-side surface of the conductor foil is 1.0 μm or less. In the manufacturing process of the film carrier tape for mounting electronic components, a pattern etching resist film is formed using a liquid resist, and the film is exposed and developed into an etching resist pattern film. When the resist-side surface of the conductor foil has great surface irregularity, the resist film has waviness and uneven thickness. Consequently, edges of the developed etching resist are irregular. According to the invention, by the resist-side surface having a surface roughness (Rzⱼᵢₛ) of not more than 1.0 μm, the conductor foil about 5 μm to 10 min thickness will be substantially uniform in thickness, with the thickness variation attributed to the resist-side surface in the range of 10 to 20%. Therefore, the linear etching resist pattern film having less irregularity at the edge can be obtained, and an overetching time which is set considering the variation of the thickness of the conductor can precisely be managed. Accordingly, the edge surface of the wiring is close to the ideal shape. Specifically, the surface roughness (Rzⱼᵢₛ) of the resist-side surface which is 1.0 μm or less is advantageous because the film carrier tape for mounting electronic components has satisfactory linearity and ensured space width.

It is preferable that the glossiness [Gs (60°)] of the resist-side surface of the conductor foil is 400 or more. In the case of a flexible copper clad laminate using a general electrolytic copper foil, the surface roughness (Rzⱼᵢₛ) of the resist-side surface is about 2.0 μm, and the glossiness [Gs (60°)] is less than 300 at most and a directional property is observed. In this case, a pitch of 40 μm is the lower limit in the wiring pattern created by forming an etching resist film on the resist-side surface. This is because, when the glossiness of the resist-side surface of the conductor foil is small or there is the directional property, followability to the wiring pattern mask is deteriorated (resolution is reduced) at edge portions of the resist pattern, due to the irregular reflection from the surface of the conductor foil even if a light source of parallel beam is employed in the exposure. Accordingly, in order to make the resist-side surface close to a mirror surface having small directional property, the glossiness [Gs (60°)] is preferably 400 or more. The glossiness of 400 or more can prevent the irregular reflection in the exposure. Partly as a result of this glossiness and partly because of the foregoing uniform thickness of the resist film, the etching resist pattern generally coincides with the wiring pattern mask and has less irregular edges. Accordingly, the irregularity is reduced at the edge portions of the wiring pattern of the film carrier tape for mounting electronic components obtained by etching the conductor foil using this resist pattern.

It is also preferable that the flexible conductor foil clad laminate is a flexible copper clad laminate composed of a surface-processed electrolytic copper foil and a base film. The surface-processed electrolytic copper foil is preferable, because it is most frequently used in the manufacture of film carrier tapes for mounting electronic components, and therefore, not only the processing conditions such as pattern etching but also the half-etching conditions are already determined according to individual facilities.

It is also more preferable that the flexible conductor foil clad laminate is a flexible copper clad laminate composed of a surface-processed electrolytic copper foil and a base film, and a surface of the surface-processed electrolytic copper foil is smoothed by etching (half etching). This laminate will be abbreviated to FCCL-HE. In copper foils for general printed wiring boards, the surface roughness (Rzⱼᵢₛ) of the resist-side surface has a lower limit of about 2.4 μm. This numerical setting has the following reason. A rigid printed wiring board has a skeletal structure material. When a glass cloth is used as the skeletal structure material, a so-called cloth texture appears as surface irregularities, so that setting a further smaller numerical value is meaningless. However, since the FCCL has no skeletal structure material, the surface of the copper foil directly affects surface characteristics. Therefore, when FCCL to be used has a surface roughness (Rzⱼᵢₛ) exceeding 1.0 μm that is the upper limit value in the present invention, it is preferable that the surface is smoothed by etching to a surface roughness (Rzⱼᵢₛ) of 1.0 μm or less.

It is preferable that the flexible conductor foil clad laminate is a flexible copper clad laminate (FCCL-HE) composed of a surface-processed electrolytic copper foil and a base film wherein a surface of the surface-processed electrolytic copper foil is smoothed by half etching, and the FCCL-HE is prepared from a flexible copper clad laminate starting material (FCCL-SM) in which a surface-processed electrolytic copper foil has a resist-side surface with a surface roughness (Rzⱼᵢₛ) of 1.5 μm or less. As described above, the half-etching has a trade-off relationship between the smoothing of the surface roughness of the exposed copper foil surface and the in-plane variation in thickness. Therefore, the starting material for the FCCL-HE preferably has a surface roughness (Rzⱼᵢₛ) which is not so apart from objective 1.0 μm, and specifically the surface roughness of the starting material is preferably not more than 1.5 μm. The use of such starting material is preferable for forming FCCL-HE which has the smooth resist-side surface and is excellent in uniformity in thickness.

It is also more preferable that the flexible conductor foil clad laminate is a flexible copper clad laminate (FCCL-HE) composed of a surface-processed electrolytic copper foil and a base film wherein a surface of the surface-processed electrolytic copper foil is smoothed by half etching, and the FCCL-HE is prepared from a FCCL-SM by etching a surface-processed electrolytic copper foil which constitutes the FCCL-SM and which is 9 μm to 23 μm in thickness, to not less than half the original thickness. The original thickness of the electrolytic copper foil layer of the FCCL-SM can be freely changed depending on the final thickness of the conductor. Considering easy production of the FCCL-SM and the fact that conductors used in conventional film carrier tapes for mounting electronic components generally have a thickness of 5 μm to 12 μm, it is preferable that the original thickness of the surface-processed electrolytic copper foil as a base is 9 μm to 23 μm. Not more than half the original thickness that is removed by the half etching is a level such that the in-plane variation in thickness of the copper foil can be maintained within an allowable range. Further, because the surface roughness (Rzⱼᵢₛ) of the resist-side surface of the surface-processed electrolytic copper foil which constitutes the FCCL-SM is not more than 1.5 μm, such half-etching amount is sufficient for achieving the target surface roughness (Rzⱼᵢₛ) of 1.0 μm or less.

Accordingly, by using the FCCL-SM or FCCL-HE according to the present invention, the objective film carrier tape for mounting electronic components can be obtained without adding special changes to the conventional manufacturing process. The reason why the FCCL-SM itself enables such manufacturing is that the half-etching step is optional in the present invention, that is, the adjustment of the resist-side surface is not essential. Specifically, the half-etching may be omitted if the surface roughness (Rzⱼᵢₛ) of the resist-side surface and the thickness of the copper foil meet the range of the present invention at the stage where the surface-processed electrolytic copper foil is bonded to the base film.

It is also more preferable that the flexible conductor foil clad laminate is a flexible copper clad laminate composed of a surface-processed electrolytic copper foil and a base film, and the surface-processed electrolytic copper foil constituting the flexible copper clad laminate is a glossy-surface-processed electrolytic copper foil. Considering the use of the wiring forming material according to the present invention, it is apparent that the bonded surface of the surface-processed electrolytic copper foil bonded to the base film requires both the smoothness and uniformity. When the deposition surface and the glossy surface of the electrolytic copper foil are compared, the in-plane uniformity of the glossy surface can easily be confirmed with good reproducibility compared to the deposition surface, because the glossy surface is transferred from a mechanically finished surface of a cathode drum. Therefore, the glossy surface can provide a bonded surface which is stable and uniform for achieving the objective shape and precision, and the bonding interface having stable irregularity can be obtained by bonding the glossy surface of the surface-processed electrolytic copper foil to the base film. The deposition surface that is relatively poor in uniformity can be uniformly smoothed by being half-etched under selected conditions.

It is also preferable that the film carrier tape for mounting electronic components has a difference of not more than 3.0 μm between a maximum width and a minimum width in a continuous linear wire. In film carriers having a small linewidth as in the present invention, stress is concentrated on a narrowest wire portion due to very small repeated stress applied by thermal expansion or thermal shrinkage or large stress applied in bonding components to the film carrier, whereby cracks might be generated. Therefore, it is necessary for printed wiring boards having a small linewidth, particularly flexible printed wiring boards, that a minimum width of the conductor is ensured while the variation in the linewidth is small and edge surfaces have no notch-like irregularity. Accordingly, it is preferable that the difference is 3.0 μm or less between the maximum width and the minimum width found in an area approximately 0.5 mm in length, of a linear wire that is designed to have an identical width. This difference can be used as an index to check whether there is irregularity on edge portions of the wiring and whether the linearity is satisfactory or not. More preferably, the difference between the maximum width and the minimum width is 2.0 μm or less in consideration of achieving a pitch of 20 μm. The maximum width and the minimum width described here are each an average value of 30 points measured at 1 μm pitch according to the method described later. If the degree of protrusion of the wire edge surfaces toward the space is evaluated based on this difference in order to ensure the space between the wires, an evaluation index will be a value that is half the difference between the maximum width and the minimum width. However, considering that the probability is small that the widest portions of the adjacent wires come closest to each other in the measurement area 30 μm in length, even this data evaluating the difference between the maximum width and the minimum width of the linewidth will be good for evaluating the precision of the wiring formation.

In the film carrier tape for mounting electronic components according to the present invention, the space margin calculated with the use of the following equation 2 is preferably not less than 82% in a wiring board in which the wire pitch is 20 μm to 35 μm.
Space margin(%)=(wire pitch(μm)−maximum linewidth(μm))/(wire pitch(μm)−minimum linewidth(μm))×100 [Equation 2]

In the present invention, the above-mentioned equation is used for the calculation of the space margin, taking the later-described method of measuring the linewidth into consideration. In general, when the wire pitch is large, the ensured insulation width is required to be not less than two third of the designed value, i.e., the space width between the wires. From this viewpoint, the present inventors consider that the difference between the maximum width and the minimum width of a continuous linear wire is preferably 3.0 μm or less, more preferably 2.5 μm or less, and at wire pitches of 20 μm, the difference is preferably 2.0 μm or less. Furthermore, the space margin is preferably 82% or more, more preferably 85% or more. As described herein, the requirement of the space margin becomes stricter as the wire pitch becomes small, for example, at wire pitches of twenties μm. The above preferable numerical value of the space margin in the present invention is applied when the linewidth and the space width are designed equal. The preferable value of the space margin changes when the linewidth is designed to be smaller than the space width as described above.

Even if the linewidth and the space width are designed to be equal to each other, for example, L/S=15 μm/15 μm, comparison of the average values of the linewidth or the space width among manufacturing lots shows that the linewidths or the space widths are variable (standard deviation: σₛ) among the manufacturing lots because of the variation in the etching level. In a measurement carried out by the inventors, the deviation σₛ in the linewidth relative to an objective linewidth 15 μm was about 15%. Therefore, it is meant by the linewidth being equal to the space width that the linewidth is within the range of 85% to 115% based on the half of the wire pitch. For example, if the wire pitch is 30 μm, the average value of the linewidths in which the space margin is a preferable level of 82% or more is in the range of 12.75 μm to 17.25 μm.

A manufacturing method of the film carrier tape for mounting electronic components according to the present invention is characterized in that a flexible copper clad laminate obtained by steps a and b described below is used as the flexible conductor foil clad laminate:

Step a: a glossy-surface-processed electrolytic copper foil is bonded to a base film to produce a flexible copper clad laminate starting material, the electrolytic copper foil having a surface roughness (Rzⱼᵢₛ) of a surface bonded to the base film of 2.5 μm or less, and a surface roughness (Rzⱼᵢₛ) of a resist-side surface of 1.5 μm or less;

Step b: the glossy-surface-processed electrolytic copper foil layer constituting the flexible copper clad laminate starting material is etched as required to not less than half an original thickness, thereby to make the surface roughness (Rzⱼᵢₛ) of the resist-side surface 1.0 μm or less.

The step b can be carried out using a commercially available half-etching solution and a common etching machine. Depending upon the requirement for the precision in thickness, a general etching solution for forming a wiring may be used as it is or after diluted. The etching step may be replaced by a technique in which a deposition surface of an electrolytic copper foil is half-etched and is thereby smoothed in the manufacturing of the copper foil, then the etched surface is roughened, and the copper foil is bonded to a base film. Mechanical polishing or the like may be performed in combination for the smoothing. However, achieving the smoothness and glossiness of both surfaces by half-etching the deposition surface of the thin copper foil in the absence of a support member such as a base film serving as a resist coating against an etching solution is not suitable for the industrial production because of large costs including facility costs. Furthermore, the half-etched copper foil obtained by the above replacement technique will be inferior in thickness uniformity to the raw material electrolytic copper foil. Moreover, wrinkles or the like will be caused in bonding such thin foil to a base film, and the productivity will be lowered.

When the mechanical polishing is employed for reducing the thickness of the FCCL-SM, the mechanical strain produced during the polishing causes a large dimensional change when the laminate is processed into a wiring board. Accordingly, mechanical polishing is often not recommended when fine pitches are desired. In contrast, both the thickness reduction and the smoothing can be reliably achieved by etching the surface-processed electrolytic copper foil that constitutes the FCCL-SM to not less than half the original thickness. Therefore, such etching is optimal for producing the film carrier tape for mounting electronic components having a fine pitch.

Next, the method of manufacturing the film carrier tape for mounting electronic components wherein the flexible copper clad laminate is used will be explained.

First, the film carrier tape for mounting electronic components on which a wiring pattern is formed will be described. The film carrier tape is composed of a base film, a wiring pattern formed on a surface of the base film, and an insulating resin protection layer, such as a solder resist layer or a cover lay layer, which is provided on the wiring pattern so that terminal portions are exposed.

Polyimide film, polyimideamide film, polyester film, polyphenylene sulfide film, polyetherimide film, fluorocarbon resin film, liquid crystal polymer film and the like can be used as the base film. That is, those base firms have chemical resistance to such an extent that they will not be eroded by an etching solution used at the time of half-etching or an alkaline solution used at the time of cleaning. And they have heat resistance to such an extent that they will not be thermally deformed by heating at the time of mounting electronic components. Of those base films having such properties, polyimide film is particularly preferable.

The base film generally has an average thickness of 5 to 150 μm, preferably 12 to 125 μm and particularly preferably 25 to 75 μm. Necessary through-holes or openings such as sprocket holes, device holes, folding slits, positioning holes and the like are made in the base film by punching.

The wiring pattern is formed by pattern etching the surface-processed electrolytic copper foil layer arranged on the surface of the base film as described above. The thickness of the copper foil layer is normally in the range of 2 to 70 μm and preferably 6 to 35 μm.

The surface-processed electrolytic copper foil layer may be provided on the surface of the base film by a casting method or a laminating method without using any adhesive. Alternatively, it may be provided through an adhesive layer for bonding. The adhesive used for bonding the surface-processed copper foil may be an epoxy resin adhesive, a polyimide resin adhesive or an acryl resin adhesive. The thickness of the adhesive layer is normally in the range of 1 to 30 μm and preferably 5 to 20 μm.

The wiring pattern is formed by pattern etching the surface-processed electrolytic copper foil layer formed on the surface of the base film. Specifically, the wiring pattern is formed as follows. A UV sensitive etching resist layer is formed on the surface of the surface-processed electrolytic copper foil layer. The etching resist layer is exposed and developed into a desired etching resist pattern. The surface-processed electrolytic copper foil layer is etched using the resist pattern as a masking material.

Then, the wiring pattern formed on the surface of the base film is plated as required.

The plating treatment is preferably performed by selectively using single metals such as tin, gold and nickel, and alloys such as lead-free solder alloys. A plurality of metals and alloys may be laminated to produce a composite deposit layer such as a nickel-gold deposit layer. Such composite deposit layers provide excellent bonding stability in surface-mounting an electronic component.

The thickness of the deposit layer may be appropriately selected depending on the metal but is generally in the range of 0.005 to 5.0 μm and preferably 0.005 to 3.0 μm.

After the deposit layer is formed as required, a resin protection layer is formed to cover the wiring pattern and the base film layer exposed between the wires, but terminal portions of the wiring pattern are not covered. This resin protection layer may be formed by screen printing a solder resist ink onto desired portions and curing the ink. Alternatively, the resin protection layer may be provided by thermally press bonding an adhesive-coated base film (cover layer film) which is punched out to a desired shape.

In an embodiment, the entire surface of the wiring may be plated (hereinafter, first plating treatment), the resin protection layer may be formed while terminals are exposed, and the exposed terminals may be plated (second plating treatment) with a metal or an alloy which may be the same or different from that used in the first plating treatment. The plating treatments may be electrolytic or electroless plating.

### Example

The present invention will be described by Example below without limiting the scope of the invention.

<Formation of Flexible Copper Clad Laminate>

FCCL-SM used in Example and Comparative Examples had the following surface-processed electrolytic copper foils manufactured by Mitsui Mining & Smelting Co., Ltd. Glossy-surface-processed electrolytic copper foils were, for Example, NA-VLP copper foil having a small surface roughness of the deposition surface and, for Comparative Example, SQ-VLP copper foil having a great surface roughness of the deposition surface. Further, MQ-VLP copper foil that was a deposition-surface-processed copper foil was used in Comparative Example. Each of the copper foils had a thickness of 18 μm. These electrolytic copper foils were each laminated on a polyimide resin base film having a thickness of 40 μm, as shown in FIG. 1. Thus, three FCCL-SM samples were prepared.

<Etching of FCCL-SM>

The FCCL-SM obtained as described above was half-etched using a spray-type etching machine in which a cupric chloride etching solution conventional for normal copper wiring etching was circulated. The thickness of the copper foil was reduced to 9 μm. Thus, FCCL-HE was obtained.

<Measurement of Thickness of Copper Foil after Half-Etching>

In the present invention, mass conversion is used for measuring the thickness of the copper foil. The thickness of the copper foil can be measured in cross section. However, since the thickness varies place to place and measurement errors are great, such cross sectional measurement will be unsuitable for evaluating the processing step. In the standard for copper foils, a mass per unit area is used for the actual thickness in distinction from the nominal thickness. Therefore, 10-cm square pieces were cut out and weighed before and after the half-etching of the surface copper layer. Then, the reduced thickness was calculated from the mass change, thereby confirming that an objective thickness was reached.

<Measurement of Surface Roughness and Glossiness of Resist-side Surface>

The surface roughness (Rzⱼᵢₛ) and glossiness [Gs (60°)] in Example and Comparative Examples shown below were measured as follows. The surface roughness (Rzⱼᵢₛ) was measured along the transverse direction (TD) of the surface-processed electrolytic copper foil by using a contact-type roughness tester in accordance with the provision of JIS C 6515. Since there was no particular standardized measurement method of glossiness for the usage according to the present invention, the glossiness was measured as follows. Measurement beam was applied to the surface of the surface-processed electrolytic copper foil at an incident angle of 60° along the machine direction (MD) of the copper foil. The intensity of the beam reflected at a reflection angle of 60° was measured using a digital angle variation glossimeter (VG-2000 manufactured by Nippon Denshoku Industries Co., Ltd.) on the basis of JIS Z 8741-1997 describing a measurement method of glossiness.

<Formation of Film Carrier Tape for Mounting Electronic Components>

A film carrier tape for mounting electronic components having a pattern of a wire pitch of 30 μm was obtained using the flexible copper clad laminate in accordance with the aforesaid process.

<Measurement of Linewidth>

A commercially available CNC (Computerized Numerical Control) image processing device for examination of printed wiring boards was used for measuring the linewidth. Specifically, the film carrier tape for mounting electronic components had L/S of 15 μm/15 μm, and a linear wire portion having a length of 0.5 mm was measured for the bottom linewidth at an interval of 1 μm. Since the resolution of the image processing device was 3 μm, an average value of continuous thirty points was employed as a representative value of the evaluated portion, and 470 such representative values were obtained by shifting the measurement starting point by 1 μm. The maximum value and the minimum value of the representative values are shown in Table 1.

The data of the linewidth obtained as described above shows that the samples had different levels of overetching. The space margin (%) was obtained with the use of the following equation.
Space margin(%)=(wire pitch(μm)−maximum linewidth(μm))/(wire pitch(μm)−minimum linewidth(μm))×100 [Equation 3]

TABLE 1

| | | | Comparative | Comparative |
|---|---|---|---|---|
| | | Example 1 | Example 1 | Example 2 |
| Bonded surface | | Glossy Surface | Glossy Surface | Deposition |
| | | | | Surface |
| Surface Roughness | Bonded surface | 2.1 | 2.0 | 3.1 |
| (Rzⱼᵢₛ: μm) | Resist-side | 0.83 | 1.68 | 1.35 |
| | surface | | | |
| Glossiness of Resist-side Surface | | 530 | 320 | 460 |
| [Gs (60°)] | | | | |
| Linewidth | Average Value | 14.1 | 15.0 | 16.0 |
| (Measured Value) | Maximum Value | 15.2 | 16.7 | 17.7 |
| (μm) | Minimum Value | 12.9 | 13.6 | 14.2 |
| | Standard | 0.44 | 0.50 | 0.67 |
| | Deviation | | | |
| | Range | 2.3 | 3.1 | 3.5 |
| | Coefficient of | 0.52% | 0.56% | 0.70% |
| | Variation | | | |
| Folding Endurance (MIT Method: | | 100% | 89% | 85% |
| percentage relative to Data of Example | | | | |
| 1 (100%) | | | | |
| Appearance | Visually Observed | Good | Relatively Good | Bad |
| | Linearity | | | |

### Example 1

In Example 1, FCCL-SM/NA was fabricated using the NA-VLP copper foil. In this copper foil, the surface roughness (Rzⱼᵢₛ) of the deposition surface was 1.2 μm (before the half-etching). The surface roughness (Rzⱼᵢₛ) was 2.1 μm on the bonded surface (the glossy surface of the surface-processed electrolytic copper foil) which had been roughened with copper particles whose average particle diameter was about 0.8 μm.

<FCCL-HE/NA>

The surface roughness (Rzⱼᵢₛ) of the resist-side surface of the FCCL-HE/NA obtained by half-etching the FCCL-SM/NA was 0.83 μm, and the glossiness [Gs (60°)] of the resist-side surface was 530.

<Linewidth>

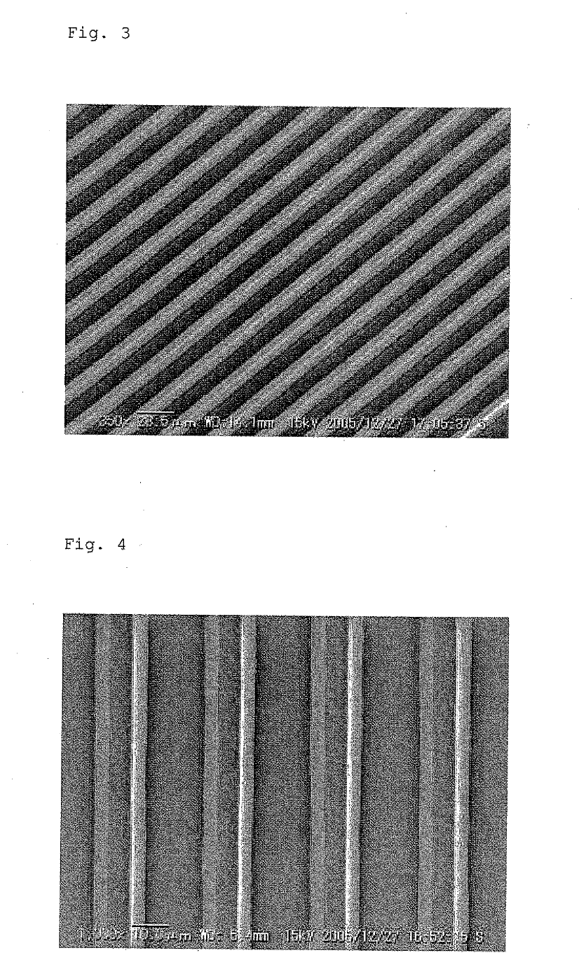

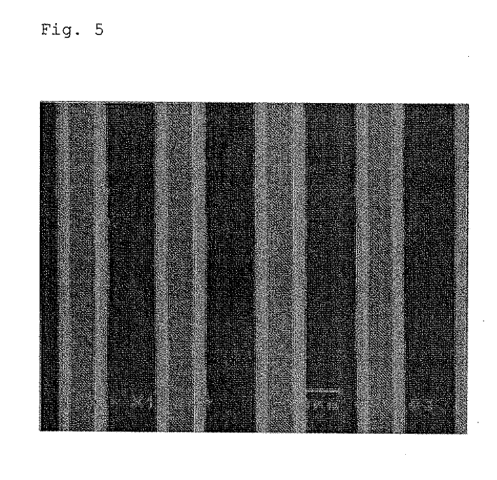

The measured value of the linewidth of the film carrier tape for mounting electronic components obtained as described above was 14.1 μm on average, 15.2 μm at maximum and 12.9 μm at minimum. The difference between the maximum value and the minimum value was 2.3 μm. The space margin was 87%. FIGS. 3 and 4 show SEM photographs of the wiring pattern.

<Folding Endurance>

The film carrier tape for mounting electronic components was tested by an MIT test for evaluating the folding endurance of the wiring portion covered with the solder resist. The folding endurance was good.

### Comparative Example 1

In Comparative Example 1, FCCL-SM/SQ was fabricated using the SQ-VLP copper foil. In this copper foil, the surface roughness (Rzⱼᵢₛ) of the deposition surface was 2.8 μm (before the half-etching). The surface roughness (Rzⱼᵢₛ) was 2.0 μm on the bonded surface (the glossy surface of the surface-processed electrolytic copper foil) which had been roughened with copper particles whose average particle diameter was about 0.8 μm.

<FCCL-HE/SQ>

The surface roughness (Rzⱼᵢₛ) of the resist-side surface of the FCCL-HE/SQ obtained from the FCCL-SM/SQ was 1.68 μm, and the glossiness [Gs (60°)] of the resist-side surface was 320.

<Linewidth>

The film carrier tape for mounting electronic components obtained by using the FCCL-HE/SQ was measured for linewidth in the same manner and based on the same positions as in Example. As a result of the measurement, the average value was 15.0 μm, the maximum value was 16.7 μm, and the minimum value was 13.6 μm. The difference between the maximum value and the minimum value was 3.1 μm. The space margin was 81%. FIG. 5 shows a SEM photograph of the wiring pattern.

<Folding Endurance>

The film carrier tape for mounting electronic components was tested by an MIT test for evaluating the folding endurance of the wiring portion covered with the solder resist. The folding endurance was relatively poor, with the number of folding times to breakage being 89% that of Example.

### Comparative Example 2

In Comparative Example 2, FCCL-SM/MQ was fabricated using the MQ-VLP copper foil having a thickness of 18 μm. The deposition surface thereof was roughened with copper particles whose average particle diameter was about 0.8 μm under the same conditions as those for the NA-VLP copper foil used in Example. The surface roughness (Rzⱼᵢₛ) of the bonded surface was 3.1 μm, and the surface roughness (Rzⱼᵢₛ) of the resist-side surface was 1.6 μm.

<FCCL-HE/MQ>

The surface roughness (Rzⱼᵢₛ) of the resist-side surface of the FCCL-HE/MQ obtained from the FCCL-SM/MQ was 1.35 μm, and the glossiness [Gs (600)] of the resist-side surface was 460.

<Linewidth>

The film carrier tape for mounting electronic components obtained by using the FCCL-HE/MQ was measured for linewidth in the same manner and based on the same positions as in Example. As a result of the measurement, the average value was 16.0 μm, the maximum value was 17.7 μm, and the minimum value was 14.2 μm. The difference between the maximum value and the minimum value was 3.5 μm. The space margin was 78%.

<Folding Endurance>

The film carrier tape for mounting electronic components was tested by an MIT test for evaluating the folding endurance of the wiring portion covered with the solder resist. The folding endurance was relatively poor, with the number of folding times to breakage being 85% that of Example 1.

### Comparison of Example 1 and Comparative Example 2

It is apparent from the comparison between Example 1 and Comparative Example 2 that the surface roughness and glossiness of the bonded surface affect the finished state, linewidth and linearity of the wiring of the film carrier tape for mounting electronic components.

### Comparison of Example 1 and Comparative Example 1

It is apparent from the comparison between Example 1 and Comparative Example 1 that not only the surface roughness and glossiness of the bonded surface but also the surface roughness and glossiness of the resist-side surface are important. Specifically, because the thickness of the conductor is small to achieve a desired fine pitch of the film carrier tape for mounting electronic components, the irregularity of the resist-side surface has a greater coefficient relative to the conductor thickness. The variation in the overetching time in the production of the wiring (and the variation in quality of the etching solution) leads to a variation in undercut amount to directly affect the formation precision of the wiring.

As apparent from the aforesaid description, the copper layer preferably has a uniform thickness for easy control of the overetching time at a fixed level. In order that the resist layer is formed in a uniform thickness and the resist is developed with good resolution to show satisfactory edge surfaces, the smooth resist-side surface of the copper layer is apparently preferable. When these preferable conditions are satisfied, the material is not limited to electrolytic copper foils, and rolled copper foils and conductor foils of different kinds will be employable by optimizing processing conditions. In the present invention, the smoothness of the resist-side surface is represented by the surface roughness (Rzⱼᵢₛ) and glossiness. However, the present inventors consider that film carrier tapes for mounting electronic components which have a finer wiring pattern may be manufactured more easily by employing techniques capable of analyzing the surface state more precisely. For example, Rmax may be used as an index of the surface roughness, or methods other than the contact-type method may be used, for example an optical technique that is a general technique for analyzing a surface of IC silicon wafer.

The film carrier tape for mounting electronic components obtained by the manufacturing method according to the present invention has a wiring pattern with a finer pitch than achieved previously while ensuring connection reliability with a liquid crystal driver or the like mounted thereon. The film carrier tape facilitates improving the performance of flat paned is plays.

1. A film carrier tape for mounting electronic components obtained by using a flexible conductor foil clad laminate comprising a conductor foil and a base film, wherein the surface roughness (Rzⱼᵢₛ) of a surface of the conductor foil bonded to the base film is 2.5 μm or less, and the surface roughness (Rzⱼᵢₛ) of a resist-side surface of the conductor foil is 1.0 μm or less.

2. The film carrier tape for mounting electronic components according to claim 1, wherein the glossiness [Gs (60°)] of the resist-side surface of the conductor foil is 400 or more.

3. The film carrier tape for mounting electronic components according to claim 1, wherein the flexible conductor foil clad laminate is a flexible copper clad laminate comprising a surface-processed electrolytic copper foil and a base film.

4. The film carrier tape for mounting electronic components according to claim 1, wherein the flexible conductor foil clad laminate is a flexible copper clad laminate comprising a surface-processed electrolytic copper foil and a base film and a surface of the surface-processed electrolytic copper foil is smoothed by etching.

5. The film carrier tape for mounting electronic components according to claim 1, wherein the flexible conductor foil clad laminate is a flexible copper clad laminate comprising a surface-processed electrolytic copper foil and a base film wherein a surface of the surface-processed electrolytic copper foil is smoothed by etching, and the flexible copper clad laminate is prepared from a flexible copper clad laminate starting material in which a surface-processed electrolytic copper foil has a resist-side surface with a surface roughness (Rzⱼᵢₛ) of 1.5 μm or less.

6. The film carrier tape for mounting electronic components according to claim 1, wherein the flexible conductor foil clad laminate is a flexible copper clad laminate comprising a surface-processed electrolytic copper foil and a base film wherein a surface of the surface-processed electrolytic copper foil is smoothed by etching, and the flexible copper clad laminate is prepared from a flexible copper clad laminate starting material by etching a surface-processed electrolytic copper foil which constitutes the starting material and which is 9 μm to 23 μm in thickness, to not less than half the original thickness.

7. The film carrier tape for mounting electronic components according to claim 1, wherein the flexible conductor foil clad laminate is a flexible copper clad laminate comprising a surface-processed electrolytic copper foil and a base film, and the surface-processed electrolytic copper foil constituting the flexible copper clad laminate is a glossy-surface-processed electrolytic copper foil.

8. The film carrier tape for mounting electronic components according to claim 1, wherein the film carrier tape for mounting electronic components has a difference of not more than 3.0 μm between a maximum width and a minimum width in a continuous linear wire.

9. The film carrier tape for mounting electronic components according to claim 1, wherein a wiring formed in the film carrier tape has a wire pitch of 20 μm to 35 μm, the space margin in the wiring which is calculated with the use of the following Equation 1 is not less than 82%:
Space margin(%)=(wire pitch(μm)−maximum linewidth(μm))/(wire pitch(μm)−minimum linewidth(μm))×100. [Equation 1]

10. A manufacturing method of the film carrier tape for mounting electronic components obtained by using a flexible conductor foil clad laminate, characterized in that a flexible copper clad laminate obtained by steps (a) and (b) described below is used as the flexible conductor foil clad laminate, the method comprising:
Step (a): bonding a glossy-surface-processed electrolytic copper foil to a base film to produce a flexible copper clad laminate starting material, the electrolytic copper foil having a surface roughness (Rzⱼᵢₛ) of a surface bonded to the base film of 2.5 μm or less, and a surface roughness (Rzⱼᵢₛ) of a resist-side surface of 1.5 μm or less; and
Step (b): etching the glossy-surface-processed electrolytic copper foil constituting the flexible copper clad laminate starting material as required to not less than half an original thickness, thereby making the surface roughness (Rzⱼᵢₛ) of the resist-side surface of 1.0 μm or less.

11. The method of claim 10, wherein the glossiness [Gs (60°)] of the resist-side surface of the conductor foil is 400 or more.

12. The method of claim 10, wherein the flexible conductor foil clad laminate is a flexible copper clad laminate comprising a surface-processed electrolytic copper foil and a base film.

13. The method of claim 10, wherein the flexible conductor foil clad laminate is a flexible copper clad laminate comprising a surface-processed electrolytic copper foil and a base film and a surface of the surface-processed electrolytic copper foil is smoothed by etching.

14. The method of claim 10, wherein the flexible conductor foil clad laminate is a flexible copper clad laminate comprising a surface-processed electrolytic copper foil and a base film wherein a surface of the surface-processed electrolytic copper foil is smoothed by etching, and the flexible copper clad laminate is prepared from a flexible copper clad laminate starting material in which a surface-processed electrolytic copper foil has a resist-side surface with a surface roughness (Rzⱼᵢₛ) of 1.5 μm or less.

15. The method of claim 10, wherein the flexible conductor foil clad laminate is a flexible copper clad laminate comprising a surface-processed electrolytic copper foil and a base film wherein a surface of the surface-processed electrolytic copper foil is smoothed by etching, and the flexible copper clad laminate is prepared from a flexible copper clad laminate starting material by etching a surface-processed electrolytic copper foil which constitutes the starting material and which is 9 μm to 23 μm in thickness, to not less than half the original thickness.

16. The method of claim 10, wherein the flexible conductor foil clad laminate is a flexible copper clad laminate comprising a surface-processed electrolytic copper foil and a base film, and the surface-processed electrolytic copper foil constituting the flexible copper clad laminate is a glossy-surface-processed electrolytic copper foil.

17. The method of claim 10, wherein the film carrier tape for mounting electronic components has a difference of not more than 3.0 μm between a maximum width and a minimum width in a continuous linear wire.

18. The method of claim 10, wherein a wiring formed in the film carrier tape has a wire pitch of 20 μm to 35 μm, the space margin in the wiring which is calculated with the use of the following Equation 1 is not less than 82%:
Space margin(%)−(wire pitch(μm)−maximum linewidth(μm))/(wire pitch(μm)−minimum linewidth(μm))×100. [Equation 1]
